(19) United States
(12) Patent Application Publication
(10) Pub. No.: US 2024/0314118 A1
(43) Pub. Date: Sep. 19, 2024

(54) SECURE MULTI-FACTOR AUTHENTICATION

(71) Applicant: Novoshield Ltd, Tel Aviv-Yafo (IL)

(72) Inventor: Lior KESHET, Tel Aviv-Yafo (IL)

(73) Assignee: Novoshield Ltd, Tel Aviv-Yafo (IL)

(21) Appl. No.: 18/120,476

(22) Filed: Mar. 13, 2023

(51) Int. Cl. H04L 9/40

(52) U.S. Cl. CPC H04L 63/0838; H04L 2463/082

(57) ABSTRACT

Disclosed herein is a method of automating Multi-Factor Authentication (MFA) to securely authenticate users accessing secure online resources, comprising obtaining access credentials of one or more users using one or more client devices to access one or more secure online resources, transmitting the access credentials to the respective online resource(s), intercepting, automatically via a background process, one or more MFA tokens transmitted by the respective secure online resource(s) to the respective client device(s) in response to receiving the access credentials, and transmitting, automatically in a background process, the MFA token(s) to the respective secure online resource(s). The secure online resource(s) is configured to authenticate the one or more users according to the received one or more MFA tokens and grant or deny the one or more users access accordingly.

### BACKGROUND

The present invention, in some embodiments thereof, relates to Multi-Factor Authentication (MFA) of users accessing secure online resources and, more specifically, but not exclusively, to securing MFA by deploying a software agent configured to automate the MFA with reduced and potentially no user intervention to reduce or eliminate the MFA's vulnerability to human factor based cyberattacks including social engineering.

Online services, platforms, systems, and applications which rapidly expand to practically any aspect of modern life are highly exposed to cyber threats. A plethora of cyber-attacks are constantly launched by malicious parties in attempt to gain access to secure and/or private information, gain control over online assets and/or funds, compromise systems, networks, services and/or platforms to name just a few goals of the malicious cyber activity.

To counter the cyber threats and risks, cyber security measures are also constantly developed, deployed and enhanced to effectively detect, and potentially mitigate such cyber-attacks in order to secure online assets, funds, data, accounts, and/or the like, collectively designated online assets.

One common practice for securing online assets is providing access to them subject to user authentication in which users are required to provide evidence to verify their identity and prove they are who they claim to be. However, reliable authentication may be a major concern since many of the cyber-attacks are directed to compromise and intercept the authentication of users, for example, access credentials such as, for example, user names (username), passwords, access codes, and/or the like. The malicious party may then use the intercepted authentication data and impersonate as legitimate users to fraudulently gain access to their secure, sensitive and/or private assets.

Most if not all cyber security authentication measures are based on verifying one or more of three factors associated with each user. The first factor may include something the user knows, for example, access credentials such as, for example, a password, a code, a token, Personal Identification Information (PII), and/or the like. The second factor may be something the user has, for example, an associated client device (e.g., mobile phone, laptop, desktop, tablet, wearable device, etc.), an identification hardware (e.g, access key fob, etc.), and/or the like. The third factor may be something the user is, i.e., biometric authentication based on verification of one or more biometric features, for example, fingerprint, face, iris, voice, and/or the like.

### SUMMARY

According to a first aspect of the present invention there is provided a computer implemented method of automating multi-factor authentication (MFA) to securely authenticate users accessing secure online resources, comprising using one or more processors to execute a computer program code for:
Obtaining access credentials of one or more users using one or more client devices to access one or more secure online resources.
Transmitting the access credentials to the one or more secure online resources.
Intercepting, automatically via a background process, one or more MFA tokens transmitted by the one or more secure online resources to the one or more client devices in response to receiving the access credentials.
Transmitting, automatically in a background process, the one or more MFA tokens to the one or more secure online resources configured to authenticate the one or more users according to the received one or more MFA tokens and grant or deny the one or more users access accordingly.

According to a second aspect of the present invention there is provided an authentication apparatus for automating multi-factor authentication (MFA) to securely authenticate users accessing secure online resources, comprising a program store storing a code, and one or more processors coupled to the program store. The one or more processors are configured to execute the code. The code comprising:
Code instructions to receive access credentials inserted by one or more users using one or more client devices to access one or more secure online resources.
Code instructions to transmit the access credentials to the one or more secure online resources.
Code instructions to intercept, automatically in a background process, one or more MFA tokens transmitted by the one or more secure online resources to the one or more client devices in response to receiving the access credentials.
Code instructions to transmit, automatically in a background process, the one or more MFA tokens to the one or more secure online resource configured to authenticate the one or more users according to the received one or more MFA tokens and grant or deny the one or more users access accordingly.

In a further implementation form of the first, and/or second aspects, the one or more users access the one or more secure online resources via a first communication channel of the one or more client devices while the one or more MFA tokens are received via a second communication channel of the one or more client devices.

In an optional implementation form of the first, and/or second aspects, the one or more MFA tokens are discarded before presented to the one or more users.

In an optional implementation form of the first, and/or second aspects, one or more user interfaces of the one or more client devices are controlled to prevent the one or more users from manually inserting the one or more MFA tokens.

In a further implementation form of the first, and/or second aspects, the one or more user interfaces are controlled to prevent manual insertion of the one or more MFA tokens in case the one or more secure online resources is not identified as an authorized resource.

In an optional implementation form of the first, and/or second aspects, the one or more secure online resources are verified as genuine before enabling the one or more users to access the one or more online resources.

In a further implementation form of the first, and/or second aspects, the access credentials are inserted by the one or more users using one or more user interfaces of the one or more client devices.

In an optional implementation form of the first, and/or second aspects, access credentials are generated automatically for the one or more secure online resources and are concealed from the one or more users.

In an optional implementation form of the first, and/or second aspects, one or more user interfaces of the one or more client devices are monitored to detect user input potentially matching one or more stored encrypted initial parts of the access credentials by:
Intercepting user input gradually inserted by the one or more users via the one or more user interfaces.
Gradually encrypting the intercepted user input.
Repeatedly matching between the resultant encrypted user input and the one or more stored encrypted initial parts.

In an optional implementation form of the first, and/or second aspects, one or more actions are initiated in response to detecting user input matching the one or more stored encrypted initial parts. The one or more actions are members of a group consisting of: generating one or more notifications, and controlling one or more user interfaces of the one or more client devices to prevent the one or more users from manually inserting further portions of the access credentials.

In an optional implementation form of the first, and/or second aspects, one or more code segments executed by the one or more secure online resources are verified to match corresponding stored known good one or more code segments before transmitting the access credentials to the one or more secure online resources.

In a further implementation form of the first, and/or second aspects, the one or more code segments comprise one or more common code segments excluding user specific code and thus executed similarly for a plurality of users.

In a further implementation form of the first, and/or second aspects, the one or more code segments comprise one or more user specific code segments adjustable according to one or more user attributes relating to each of the one or more users and/or the one or more client device. The one or more user attributes are members of a group consisting of: personal information, geolocation, timing, and an operational parameter of the client device.

In a further implementation form of the first, and/or second aspects, the one or more user specific code segments generated specifically with respect to the one or more users are associated with a user specific signature expressing a unique execution of the one or more user specific code segments for the respective user.

In a further implementation form of the first, and/or second aspects, the one or more MFA tokens comprise a One-Time Password (OTP).

In a further implementation form of the first, and/or second aspects, receiving of the one or more MFA tokens from the one or more secure online resources is done via one or more messages. The one or more messages are members of a group consisting of: a text message, an email message, a voice message, and an application notification.

In a further implementation form of the first, and/or second aspects, the one or more processors comprises one or more processor of one or more of the client devices.

In a further implementation form of the first, and/or second aspects, the one or more processors comprises one or more processors of one or more servers processing and/or providing access to the one or more secure online resources.

In a further implementation form of the first, and/or second aspects, the one or more processors comprises one or more processors of a traffic control service deployed to route all communication traffic between the one or more client devices and the one or more secure online resources.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard, mouse or touch screen are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of using an access agent for automating Multi-Factor Authentication (MFA) order to secure the MFA, according to some embodiments of the present invention; and

FIG. 2 is a schematic illustration of an exemplary system for automating MFA in order to secure the MFA, according to some embodiments of the present invention.

### DETAILED DESCRIPTION

The present invention, in some embodiments thereof, relates to MFA of users accessing secure online resources and, more specifically, but not exclusively, to securing MFA by deploying a software agent configured to automate the MFA with reduced and potentially no user intervention.

Such an automation or enveloping of the MFA process may be beneficial as an additional mitigation from cyberattacks such as, for example, social engineering which attempt to entice the user to disclose their permanent credentials (username, password, and the like) as well as their volatile or additional factors such as one time passwords, tokens or codes.

Many types of cyber-attacks may be initiated in attempt to compromise systems, services, networks, platforms, accounts and/or the like and gain access and/or control over private, sensitive, and/or secure online assets, funds, and/or information of users, companies, enterprises, organizations (private and/or government), and/or the like.

One such cyber-attack is Account Takeover (ATO) in which a malicious attacker attempts to gain unauthorized access to an account of some user at some secure online resource, for example, a secure service, a secure system, a secure platform, and/or the like to which access may be restricted and granted only after successful authentication of authorized users.

The secure online resources may comprise, for example, online finance services (e.g. bank account, credit/debit card account, etc.), remote access systems (e.g., office resource, company database, etc.), enterprise platforms, leisure content services (e.g., social media network, a streaming service, a gaming platform, etc.), and/or the like. Exemplary secure online resources which may be targeted by cyber-attacks may include, for example, email accounts (private and/or work related), cloud based and/or Software as a Service (SaaS) accounts used for personal and/or business (e.g., Dropbox, iCloud, Salesforce, etc.), organization Virtual Private Network (VPN) accounts, bank accounts, and/or other types of user accounts with various financial institution, cryptocurrency wallets, organization accounts required to access work environment, and many more.

ATO cyber-attacks may be initiated for one or more unlawful gains such as, for example, transferring funds, obtaining knowledge (unlawful surveillance), retrieving sensitive, secure, and/or private data, using social media for various reasons, and/or the like.

For brevity, the term ATO may be used herein after to describe one or more cyber-attacks. This however, should not be construed as limiting since the methods and systems described here may be similarly employed to mitigate other types of cyber-attacks initiated in attempt to gain unauthorized access to secure online resources.

ATO cyber-attacks may be executed using access credentials of authorized users which may obtained in one or more methods, for example, though leakage, security breach and/or theft of access credential, via open sources such as social media, public records, and/or the like in which information that may be used by users as authentication data may be freely obtained. Specifically, these ATO attacks can be executed by ‘social engineering’—a host of methods designed to induce human error on the part of a user which will result in divulging sensitive credentials to a remote attacker, for example, username, passwords, and one-time access tokens, among others.

However, one highly common and popular avenue for obtaining access credentials of users is through the use of phishing attacks which are a type of social engineering where an attacker sends a fraudulent (e.g., spoofed, fake, or otherwise deceptive) message, for example, a text message, an email message, etc. containing a link leading to an online resource impersonating a known brand, designed to trick a human victim into revealing sensitive information to the attacker or to deploy malicious software on the victim's infrastructure.

Phishing attacks have become increasingly sophisticated and often transparently mirror (replicate) the secure online resource (e.g., website) targeted by the ATO thus enabling the attacker to observe the fraudulent secure online resource website while the victim user is navigating through the website, and transverse any additional security boundaries with the victim user.

Another cyber-attack launched in attempt to gain access credentials of users to secure online resources is Web Skimming (also known as JavaScript Skimming) in which an attacker may inject malicious code (e.g., JavaScript, etc.) into a website of a secure online resource and extract data from one or more Hypertext Markup Language (HTML) forms filled by a user with information, for example, his access information and/or credentials. The injected malicious code may then transmit the extracted data to one or more servers controlled by the attacker.

In attempt to effectively counter various types of cyber-attacks, for example, ATO, many authentication schemes are based on MFA in which two or more of the user's factors must be verified in order to successfully authenticate the user and grant him access to the secure online resource(s). For example, in a Two Factor Authentication (2FA) system, the user may be authenticated subject to verifying two of his factors, for example, access credentials such as, for example, a password, a code, etc. (first factor), and possession of an associated asset (second factor) such as, for example, a mobile phone, an email account, etc.

However, modern phishing attacks may employ means to bypass the MFA.

For example, an attacker may set up a website which is an exact replica of a targeted secure online resource website in a different domain, for example, “abcdefg.co” designed to imitate a domain of the targeted secure online resource website, for example, “abcdefg.com” and deceive users accessing the replicated website and providing their access credentials, while the attacker simultaneously accesses the real website of the targeted secure online resource with the provided access credentials.

In response to the access of the attacker to the real website, the secure online resource may transmit one or more MFA tokens (e.g., code, string, password, etc.) to the user 202, for example, a text message transmitted to a client device (e.g. mobile phone) associated with the user, an email message to an email account of the user, and/or the like. The user may then provide (e.g., insert, type, enter) the MFA token(s) he received from the secure online resource to the replicated website controlled by the attacker. The attacker may then use the MFA token(s) to authenticate as the user at the real website of the secure online resource and gain access to the account of the user at the secure online resource.

According to some embodiments of the present invention, there are provided methods, systems and computer program products for securing MFA by deploying a software agent configured to automate the MFA with little and typically no intervention of the user thus reducing probability of leakage and/or exposure of user's access credentials and/or MFA tokens to malicious parties, for example, a resident malware, a replicated fraudulent secure online resource, and/or the like.

The software access agent which may be deployed in a client device used by the user to access online resource, in one or more of the secure online resources, and/or in one or more access servers controlling access of the user to online resources (e.g., gateway, firewall, load balancer, etc.) may be configured to monitor network traffic of the client device and identify online resources accessed by the user.

The access agent may verify that one or more secure online resources are genuine and/or authorized for access to the user before enabling the user to access them, i.e., provide his access credentials. The access agent may therefore enable (allow) the user to provide the access credentials responsive to determining and/or detecting, that the accessed secure online resource is genuine and/or authorized for access. However, responsive to determining that the accessed secure online resource is not authorized for access to the user, the access agent may transmit one or more alert notifications and may be even prevent the user from providing his access credentials.

In case, i.e., responsive to detecting, the accessed secure online resource is identified as legitimate and authorized for access to the user, the access agent may obtain the access credentials of the user and transmit them to the secure online resource. For example, the access agent may intercept the access credentials provided by the user via one or more users interfaces of his client device, for example, a keyboard, a touchscreen, etc. In another example, the access agent may fetch the access credentials of the user from one or more records storing access credentials of the user to one or more secure online resources.

Optionally, the access agent may automatically generate access credentials for the user such that the user is not aware and not exposed to the automatically generated access credentials and may therefore not accidently leak them.

In response to receiving the access credentials, the secure online resource may transmit one or more MFA tokens to the user via one or more communication channels which are typically different from the communication channel used by the user to access the secure online resource. For example, the user may use one or more access applications, for example, a web browser, a mobile application, and/or the like to access the secure online resource via the internet. In such case, the secure online resource may transmit the MFA token(s) via another communication channel(s), for example, via one or more text messages transmitted to (a phone number of) the client device (e.g., mobile phone) associated with the user, one more email messages delivered to an email account (address) associated with the user, and/or the like.

The access agent may intercept the MFA token(s), typically without exposing it to the user. For example, the access agent may communicate with one or more applications and/or services which received the MFA token(s), for example, a text messaging application, a text messaging service, an email application, email server, and/or the like to obtain the MFA token(s).

Optionally, the access agent may discard the MFA token(s) received from the secure online resource before presented, exposed, and/or accessed by the user to prevent the user from learning of the MFA token(s). For example, the access agent may communicate with one or more of the applications and/or services which received the MFA token(s) and instruct them to delete the MFA token(s) and/or message(s) comprising the MFA token(s).

Optionally, the secure online resource may transmit one or more MFA tokens to one or more accounts (e.g., email accounts), channels (phone number, WhatsApp identity, etc.) and/or resources which are dedicated to the access agent and are concealed and inaccessible to the user.

The access agent may then transmit the intercepted MFA token(s) to the secure online resource which may verify the MFA token(s) to complete the MFA process. In case, i.e., responsive to, successful verification of the MFA token(s) jointly with the access credentials, access may be granted for the user to the secure online resource. However, in case, i.e., responsive to, the secure online resource failure to successfully verify the MFA token(s), access to the secure online resource may be denied for the user.

The automated access agent deployed to secure MFA may present major benefits and advantages over existing MFA methods, systems, and/or techniques.

First, receiving the MFA token(s) and transmitting it to the secure online resource on behalf of the user, typically without exposing the MFA token(s) to the user and optionally discarding them may significantly increase security and immunity of the user 202 and his associated client device 200 to ATO attacks since the user is unaware of the MFA token(s) and may be therefore unable to inadvertently provide it to a malicious party as may happen in the existing methods.

Moreover, since the MFA token(s) are not presented (shown, displayed) and thus not available to the user, the MFA token(s) may not be easily compromised, for example, intercepted, captured, recorded, leaked, and/or the like by potential malicious parties, for example, a person and/or a resident malware monitoring user interfaces of the client device. For example, since the MFA token(s) are not presented to the user, a malware monitoring screen content of the client device may be unable to intercept the MFA token(s). In another example, since the user does not manually provide the MFA token(s), for example, via a keyboard, a touchscreen and/or the like, a malware logging keystrokes of the keyboard may be unable to intercept the MFA token(s). In another example, since the MFA token(s) are not manually provided via one or more fields in the (webpage of) the secure online resource, a malware monitoring these fields may be unable to intercept the MFA token(s).

Furthermore, the automated access agent may identify domains, URLs, and/or addresses of fraudulent online resources replicating genuine secure online resources and distinguish them from the genuine resources significantly more effectively than the users themselves as may be done in the existing MFA methods since human users may be much less sensitive to minor differences in the online resources' addresses and may be thus highly exposed and/or susceptible to deception.

In addition, verifying the secure online resources before enabling users to provide their access credentials may significantly increase immunity of the access credentials to compromise by malicious parties operating fraudulent online resources compared to the currently existing methods.

Also, automating the authentication process using the automated access agent may significantly reduce and possibly completely avoid user intervention during the authentication process which may significantly reduce authentication time and/or improve user experience of the user who is relieved from manually providing MFA token(s) as may be done by the existing authentication methods.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit.” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

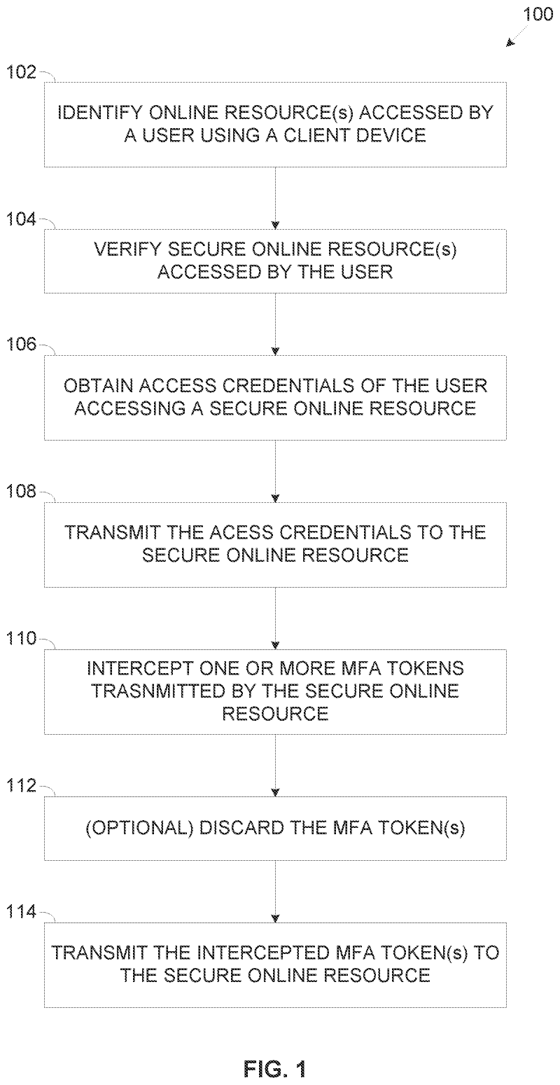

Referring now to the drawings, FIG. 1 is a flowchart of an exemplary process of using an access agent for automating MFA in order to secure the MFA, according to some embodiments of the present invention.

An exemplary process 100 may be executed by an access agent configured to automate authentication of one or more users using client devices to access one or more secure online resources, in particular, to further secure MFA based authentication.

The access agent may perform the MFA authentication process at least partially automatically on behalf of the users such that the users are not exposed to at least some of the MFA information exchanged between the accessed secure online resources and the client devices thus reducing and potentially eliminating possibility of exposing the MFA information to other, potential malicious, parties.

The automated MFA process in which the users' intervention is significantly reduced and possibly completely eliminated is therefore highly secure which makes the MFA significantly more robust and immune to malicious cyberattacks or threats initiated by malicious parties who may fraudulently impersonating as legitimate users in attempt to compromise the users' secure, private and/or sensitive, accounts, data and/or assets.

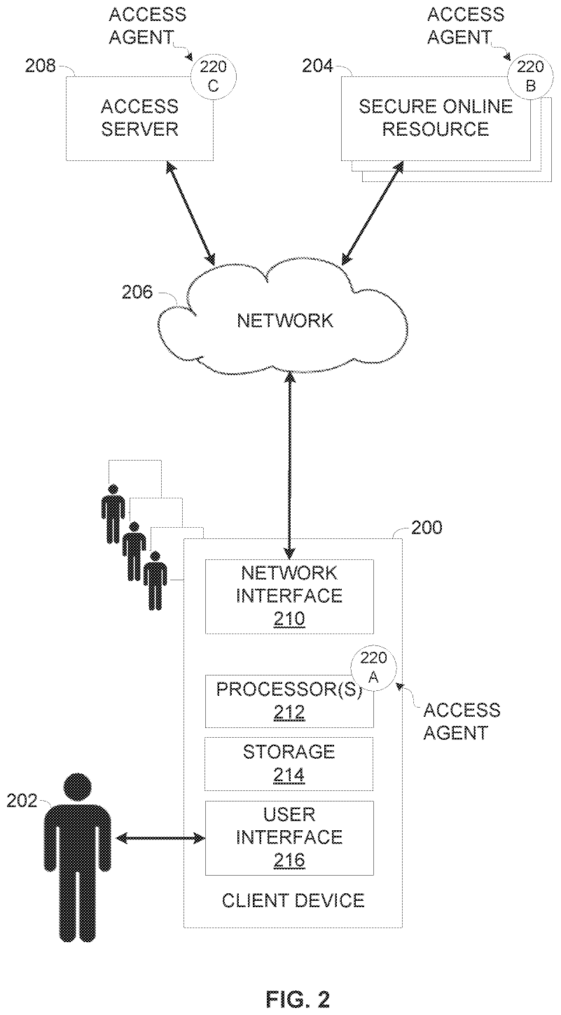

Reference is also made to FIG. 2, which is a schematic illustration of an exemplary system for automating MFA in order to secure the MFA, according to some embodiments of the present invention.

One or more users 202 may use one or more client devices 200, for example, a server, a desktop computer, a laptop computer, a Smartphone, a tablet, a Virtual Reality (VR) device, an Augmented Reality (AR) device, a proprietary client device and/or the like for accessing one or more online resources 204, for example, a webpage, a web application, an online service, an online marketplace, a cloud resource, and/or the like accessible via a network 206 comprising one or more wired and/or wireless networks, for example, a Local Area Network (LAN), a Wireless LAN (WLAN, e.g. Wi-Fi), a Wide Area Network (WAN), a Metropolitan Area Network (MAN), a cellular network, the internet, and/or the like.

In particular, the online resources 204 may be secure online resources, for example, a secure service, a secure system, a secure platform, and/or the like such as, for example, an online finance service (e.g., a banking service, a credit/debit card service, etc.), a cryptocurrency wallet, a remote access system (e.g., email service, cloud storage service, office resource, company database, etc.), a leisure content service (e.g., social media network, a streaming service, a gaming platform, etc.), and/or the like.

In order to increase and/or ensure their security, safety and/or privacy, the secure online resources 204 may restrict access to authorized users only after successful authentication of the authorized users. As such, one or more of the users 202 who are authorized to access one or more of the secure online resources 204 may be granted access to the secure online resource(s) 204 only after they successfully authenticate themselves and their identity is verified.

Each client device 200 may comprise a network interface 210 for connecting to the network 206, a processor(s) 212, and a storage 214 for storing data and/or code (program store), and a user interface 216 for interacting with an associated user 202, i.e., the user 202 that is currently using the respective client device 200.

The network interface 210 may include one or more wired and/or wireless network interfaces implemented through hardware, software, and/or firmware for connecting to the network 206. Via its network interface 210, the client device 200 may communicate, over the network 206, with one or more of the secure online resources 204.

The processor(s) 212, homogenous or heterogeneous, may include one or more processing nodes and/or cores arranged for parallel processing, as clusters and/or as one or more multi core processor(s). The storage 214 may include one or more non-transitory persistent storage devices, for example, a Read Only Memory (ROM), a Flash array, a Solid State Drive (SSD), a hard drive (HDD) and/or the like. The storage 214 may also include one or more volatile devices, for example, a Random Access Memory (RAM) component, a cache and/or the like.

The processor(s) 212 may execute one or more software and/or firmware modules such as, for example, a process, a script, an application, an agent, a utility, a tool, a device driver, an Operating System (OS), a service, a plug-in, an add-on, and/or the like each comprising a plurality of program instructions stored in a non-transitory medium (program store) such as the storage 214 and executed by one or more processors such as the processor(s) 212.

Optionally, the processor(s) 212 may include, utilize and/or apply one or more hardware elements (modules) available in the client device 200 to support one or more of the software modules executed by the client device 200, for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU) and/or the like.

The processor(s) 212 may therefore execute one or more functional modules utilized by one or more software modules, one or more of the hardware elements and/or a combination thereof. For example, the processor(s) 212 may execute an access agent 220, designated local access agent 220A which is configured to execute the process 100 and/or part thereof for automating an MFA process initiated to authenticate the associated user 202 using the respective client device 200 to access one or more of the secure online resources 204. While the functional modules, for example, the local access agent 220A are executed by the processor(s) 212 of the client devices 200, for brevity, the description may state that the functional modules are executed by the client devices 200.

The local access agent 220A may be implemented using one or more methods, techniques and/or paradigms and/or a combination thereof. For example, the local access agent 220A may be an independent stand-alone application executed by one or more of the client devices 200 used by respective users 202 to access one or more of the secure online resources 204.

In another example, the local access agent 220A may be integrated in one or more web browsers, for example, Safari, Chrome, Edge, Firefox, and/or the like executed by one or more of the client devices 200 used by respective users 202 to access one or more of the secure online resources 204. The local access agent 220A may be integrated into the web browser(s) using one or more architectures, designs, and/or implementations, for example, a plug-in, an extension, an add-on, a script, and/or the like. In another example, the local access agent 220A may be a standalone application, for example, a mobile application, a system level application or service with elevated privileges that enable it to access the user input media (such as web browser) as well as the additional authentication factor (e.g. sms, email, WhatsApp and the like), a Personal Computer (PC) application, and/or the like executed by one or more of the client devices 200 accessing one or more of the secure online resources 204. In such case, the local access agent 220A may communicate with an access application used by user 202 to access the secure online resource(s) 204, for example, a web browser, a mobile application and/or the like, for example, using an Application Programming Interface (API) of the access application.

The user interface 216 may include one or more Human-Machine Interfaces (HMI) for interacting with the user 202, for example, a keyboard, a pointing device (e.g., a mouse, a touchpad, a trackball, etc.), a screen, a touchscreen, a digital pen, a speaker, an earphone, a microphone and/or the like. The user 202 may therefore use one or more of the HMIs of the user interface 216 to interact with his associated client device 200, in particular with one or more functional modules executed by the client device 200, for example, the access agent 220 which may be used to access one or more of the secure online resources 204.

Optionally, the access agent 220 and/or part thereof may be executed remotely from the client devices 200 by one or more of the secure online resources 204. Such a remotely executed access agent 220 is designated access agent 220B herein after. Each such secure online resource 204 may comprise computing resources, for example, processor(s) such as the processor(s) 212, storage such as the storage 214, and/or the like to facilitate execution of the access agent 220B.

To this end, the access agent 220B may be installed, integrated and/or embedded in one or more webpages of one or more of the secure online resources 204 accessed by one or more of the client devices 200 used by respective users 202. For example, one or more software code segments of the access agent 220B created using one or more web code frameworks and/or languages, for example, JavaScript, HyperText Markup Language (HTML), Extensible Markup Language (XML), and/or the like may be injected into one or more webpages, websites, services, engines and/or the like of one or more of the secure online resources 204. In another example, the access agent 220B may be integrated in one or more web pages, web sites, services, engines and/or the like of one or more of the secure online resources 204 using one or more Software Design KITs (SDK) and/or through an Application Programming Interface (API) of the access agent 220B.

Alternatively, and/or additionally, the access agent 220 and/or part thereof may be executed remotely by one or more access servers 208 associated with one or more of the secure online resources 204 and configured to authenticate users 202 attempting to access the secure online resource(s) 204. The access agent 220 executed by the access server(s) 208 may be designated access agent 220C.

While one or more of the access servers 208 may comprise dedicated servers, optionally cloud based servers deployed specifically to control access to one or more of secure online resources 204, the access server(s) 208 may optionally employ resources already deployed in association with one or more of the secure online resources 204, for example, a gateway, a traffic controller, a load balancer, a security server (e.g., firewall, etc.), and/or the like.

Each access server 208 may comprise computing resources, for example, processor(s) such as the processor(s) 212, storage such as the storage 214, and/or the like which may be employed to execute of the access agent 220C. In such deployment, the access agent 220C may be installed, integrated and/or embedded in the one or more of the access servers 208 using one or more of the methods described herein before. For example, code of the access agent 220C may be injected into one or more web pages, services, applications, and/or the like executed by the access server 208. In another example, the access agent 220C may be integrated in the execution environment of the access server 208 using one or more SDKs and/or APIs of the access agent 220C.

In the remote execution deployments, in which the access agent 220 is executed remotely from the client devices 200, one or more of the client devices 200 may execute a local agent, for example, a web browser (e.g., Chrome, Safari, Firefox, Edge, Opera, etc.), a mobile application, a proprietary agent, and/or the like which is configured to communicate, via the network 206, with the remote access agents 220B and/or 220C executed by the secure online resource(s) 204 and/or the access server(s) 208 respectively and serve as intermediaries for relaying data between their associated user(s) 202 and the remote access agents 220B and/or 220C.

Optionally, the access server 208, in particular the access agent 220C may be utilized and/or implemented by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud, Microsoft Azure, Amazon Web Service (AWS) and Elastic Compute Cloud (EC2), IBM Cloud, and/or the like.

The access agent 220 may be a background process executed transparently to the user 202. For example, in case of local execution or partial local execution, the local access agent 220A may be executed by the client devices 200 in background processes with no interaction and/or intervention of users 202. In case of remote execution or partial remote execution, the remote access agents 220B and/or 220C may be executed by the secure online resource(s) 204 and/or the access server(s) 208 respectively with no interaction with users 202.

The exact implementation and/or execution of the process 100 to automate and secure MFA processes for the users 202 may obviously depend and adjust according to the deployment, architecture and/or implementation of the access agent 220. For example, the process 100 may be executed by the local access agent 220A, by the remote access agents 220B and/or 220C and/or jointly by the two or more of the access agents 220A, 220B and/or 220C.

However, for brevity, regardless of the exact deployment, architecture and/or implementation, a general access agent 220 which combines one or more of the access agents 220A, 220B and/or 220C is described herein after to execute and control the entire process 100. This means that one or more steps of the process 100 may be executed by each of access agents 220A, 220B and/or 220C and/or a combination of two or more of them.

Moreover, the steps of the process 100, executed by the processor(s) 212 of the client device 200, by the processor(s) of the secure online resource(s) 204 and/or by the processor(s) of the access server(s) 208, may be executed by any of one or more processors of theses processor(s) such that each processor of the processor(s) may execute the entire process 100 and/or part thereof or optionally take no part in the execution of the process 100.

Also, for brevity, the process 100 is described for automating MFA for a single user 202 using a respective client device 200 to access a single secure online resource 204. This however, should not be construed as limiting since, as may become apparent to a person skilled in the art, the process 100 may be easily duplicated, expanded and/or scaled for a plurality of users 202 using a plurality of client devices 200 to access a plurality of secure online resources 204.

As shown at 102, the process 100 starts with the access agent 220 identifying online resources accessed by a user 202 using his associated client device 200, specifically secure online resources 204 which require authentication of the user 202 before granting him access.

To this end, the access agent 220 may monitor one or more access applications executed by the client device 200 used by the user 202 to access online resources, for example, a web browser, a mobile application, a PC application, and/or the like. The methods employed by the access agent 220 to identify the secure online resources 204 accessed by the user 202 may depend on deployment mode and/or architecture of the access agent 220.

For example, in case of the local access agent 220A, the local access agent 220A may be integrated in one or more of the access applications, for example, a web browser used by the user 202 to access one or more of the secure online resources 204 and may detect accesses information relating to secure online resources 204, for example, a domain, a Unified Resource Locator (URL), an address, and/or the like. In another example, assuming the local access agent 220A is independent of the access application(s), the local access agent 220A may communicate with the access application(s) via their API and obtain the access information and detect access to one or more secure online resources 204 based on analysis of the access information.

In another example, in case of the remote access agents 220B and/or 220C, collectively designated remote access agents 220BC, the remote access agents 220BC may monitor network traffic originating from the client device 200 and detect one or more requests for accessing one or more secure online resources 204, for example, access to a domain, a URL, an address, and/or the like indicative of access to the secure online resource(s) 204.

As shown at 104, the access agent 220 may optionally verify that one or more of the online resources accessed by the user 202, in particular secure online resources 204, are genuine and/or authorized resources.

This verification may be done to ensure and ascertain that the online resources (e.g., website, webpage, service, etc.), specifically the secure online resources 204 are real, genuine, and valid resources rather than potentially fraudulent resources imitating as corresponding secure online resources 204 as part of a potential cyber-attack, for example, phishing, social engineering and/or the like. As such, in case (responsive to) the access agent 220 determines that an accessed online resource may be a potentially fraudulent online resource indicative of a potential cyber-attack, the access agent 220 may prevent the user 202 to access such potentially fraudulent resource.

Otherwise, i.e., responsive to verifying, detecting and/or determining that the accessed online resource is a real, genuine, and valid resource, the access agent 220 may permit the user 202 to access the verified resource.

The access agent 220 may apply one or more techniques and/or methods for identifying, evaluating, and/or determining whether online resources accessed by the user 202, specifically secure online resources 204 are authorized resources, i.e., genuine and valid online resources, or not.

For example, in case of a phishing and/or another social engineering attack, the online resources accessed by the user 202 fraudulently replicate the secure online resources 204 and be located in a domain designed to deceive the user 202 to think he is accessing a genuine secure online resources 204. In such case the access agent 220 may determine if the accessed secure online resource 204 is genuine and authorized or not based on a URL of the secure online resource 204 and/or part thereof, for example, a domain name and verify (ascertain) it is in fact a URL (webpage) that is operated and belongs to a respective service operator. For example, the access agent 220 may determine that a certain secure online resource 204, for example, accounts.google.com is genuine and authorized for access while determining that another online resource, for example, accounts.gooogle.co is potentially a fraudulent and/or phishing resource.

In another example, the access agent 220 may determine if the accessed secure online resource 204 is genuine or not by verifying one or more certificates provided by the accessed secure online resource 204 by comparing the certificate(s) to valid certificate(s) stored for the secure online resource 204. For example, the access agent 220 may compare between a hash or thumbnail of the certificate received from the secure online resource 204 and stored legitimate and valid certificate hashes. In another example, the access agent 220 may determine if the accessed secure online resource 204 is genuine or not by verifying an IP address of the secure online resource 204 compared to stored IP addresses. In another example, the access agent 220 may determine if the accessed secure online resource 204 is genuine or not by inspecting code and/or one or more attributes of the secure online resource 204, for example, hash of a running binary, check Android Package (APK) name, a manifest, an activity name, APP name, and/or the like and comparing them with code hashes and/or attributes pre-stored by the access agent 220 for one or more ‘known good’ configurations.

The access agent 220 may use one or more methods for retrieving information indicative of genuine, legitimate and thus authorized secure online resources 204 and/or indicative of potentially fraudulent, and/or fake online resources, for example, domain names, URLs, IP addresses, certificates, attributes, and/or the like.

For example, the access agent 220 may use one or more allow lists listing authorized secure online resources 204 which are genuine and approved for access by client device 200 used by the user 202. In another example, the access agent 220 may use one or more black lists listing online resources which are known to be fraudulent (fake) and are not authorized for access by the user 202. The access agent 220 may obtain, retrieve, and/or receive one or more of the allow lists and/or the block lists from one or more trusted sources, for example, an organization relating to the user 202 (e.g., company, institute, agency, etc.), a trusted 3rd party (e.g., anti-malware services, etc.), and/or the like.

In another example, the access agent 220 may determine if one or more secure online resources 204 are authorized resources based on analysis a browsing history, stored cookies, and/or the like retrieved from the access application(s) used by the user 202 to access online resources, for example, a web browser, a local agent, and/or the like indicative of secure online resources 204 which were previously successfully accessed (in the past) and are therefore considered genuine and authorized for access.

In another example, the access agent 220 may identify one or more secure online resources 204 which are genuine and authorized for access based on analysis of user information, for example, access credentials for accessing one or more authorized secure online resources 204, email and/or text messages indicative of one or more authorized secure online resources 204, and/or the like.

In another example, the access agent 220 may identify one or more applications, for example, a mobile application, a PC application, and/or the like which are genuine and authorized for access based on their relation to one or more authorized secure online resources 204, for example, a local agent of a web application (e.g., banking app, credit card app, media subscription app, etc.), and/or the like.

Another technique employed by the access agent 220 for identifying, evaluating, and/or determining legitimate and genuine secure online resources 204 which are authorized for access to the user 202 may be based on verifying that one or more code segments of the secure online resources 204 are genuine and authorized.

In particular, the access agent 220 may verify code segment(s) of the secure online resources 204 by verifying that the code segment(s) executed by the secure online resource 204 matches a corresponding stored “known good” code segment.

For example, a signature may be produced for one or more code segments of the secure online resource 204 in advance. This may be accomplished using one or more tools, functions, algorithms, and/or applications which are executed at the secure online resource 204 and configured to monitor and scan new deployed versions of code segments of the secure online resource 204. Additionally and/or alternatively, monitoring the code segments of the secure online resource 204 may be done remotely from the secure online resource 204 using one or more web clients, web crawlers, and/or the like configured to monitor the secure online resource 204 optionally with no interaction or cooperation of the provider of the secure online resource 204.

The monitoring tools, functions, algorithms, and/or applications may analyze the secure online resource 204 identify the code segments and generate a signature for one or more of the code segments. Each signature may comprise a data structure containing information which may uniquely identify the respective code segment in a reliable and tamper proof manner. For example, the signature of one or more of the code segments of the secure online resource 204 may include one or more code portions of the respective code segment, for example, JavaScript, HTML, and/or the like which is loaded and/or executed by the secure online resource 204. In another example, the signature may include an ID of the code segment, for example, a webpage, a URL, and/or the like. In another example, the signature may comprise one or more hash values computed using one or more hash functions (e.g., MD5, SHA-1, SHA-256, etc.) for one or more code portions of the respective code segment, for example, a source JavaScript file, inline JavaScript embedded in a webpage, inline JavaScript embedded in a frame, and/or the like.

Following is an exemplary structure of an exemplary signature: <Meta data-base URL, protected service, etc.) <Non-code section><Signed (MD5) code section 1><Dynamic code section 1 expected length X with standard deviation length of y><Static/signed (MD5) code section 2><Non code section><Dynamic section 2 with expected length X and standard deviation length y>< . . . >

Producing an effective signature for code segments loaded into online resources (web services) may be highly challenging since while some of the code may comprise statically loaded code, other code portions may be dynamically generated in runtime based on user attributes which may be different for different users 202. Such user attributes may include, for example, personal information, customizable portions and elements of webpages generated by a server in response to attributes related to the specific user's profile, geolocation, timing, operational parameters of the client device 200, and/or the like, for example, geographical location, target OS, web platform, browser type, user preferences, user history, and/or the like.

One or more methods, and/or techniques may be therefore applied to circumvent this limitation.

For example, the code segments analyzed to verify that the secure online resource 204 is authorized for access to the user 202 may comprise one or more common code segments excluding user specific code and thus executed similarly by a plurality of client devices 202 used by a plurality of users 202. In order to identify such common code segments, a plurality of web clients having a plurality of different user attributes may be deployed to access the secure online resource 204. For example, the web clients which may be deployed in a plurality of different geographical area, operate in a plurality of different networks and/or network topologies, execute by different client devices 202 having different hardware parameters, use different web browsers, use different user accounts, and/or the like. The execution of the code segments may be compared between the plurality of web clients and a signature may be produced for one or more of the code segments which are common and execute similarly at all of the web clients yielding a ‘signature’ structure with an expected better predictive value in proportion to the number of samples.

In another example, the code segments analyzed to verify that the secure online resource 204 is authorized for access to the user 202 may comprise one or more user specific code segments which are adjustable according to one or more of the user attributes relating to each of one or more users 202 and/or to their associated client devices 200. In such case, a user specific signature may be produced and stored for each of one or more user specific code segments for each user 202. Each user specific signature may therefore express a unique known good execution of a respective user specific code segment for a respective user 202. In order to produce user specific signatures for one or more user specific code segments of the secure online resource 204, the signature may be produced once during a first access of the user 202 to the secure online resource 204 which may be a controlled access that may be highly immune to cyber-attacks such as, for example, phishing, social engineering, and/or the like. During the first access of the user 202 using his client device 200, one or more user specific signatures may be generated which are unique to the specific user 202 and to one or more user specific code segments of the secure online resource 204. The user specific signature(s) for verification of these user specific code segments in subsequent accesses of the user 202 to the secure online resource 204.

The signatures and/or the known good code segments, whether common and/or user specific, may be locally stored in the client device 200, for example, in the storage 214 and/or in one or more remote storage locations accessible via the network 206, for example, a storage server, cloud storage service, and/or the like.

In runtime, when accessing the secure online resource 204 which may potentially be a fraudulent resource imitating as the secure online resource 204 for a phishing attack, the access agent 220 may compare between one or more code segments of the accessed online resource and corresponding known good code segments which may be retrieved from storage.

For example, the access agent 220 may compute a signature for each of one or more code segments of the accessed online resource and verify that the computed signature(s) matches corresponding stored signature(s) computed in advance for known good corresponding code segments. For example, the access agent 220 may compute and compare between signatures of one or more common code segments of the secure online resource 204 and corresponding stored signatures produced for corresponding known good common code segments. In another example, the access agent 220 may compute and compare between signatures of one or more user specific code segments of the secure online resource 204 and corresponding stored signatures produced for corresponding known good user specific code segments. In another example, the access agent 220 may compute and compare between a combination of signatures computed for both common and user specific code segments of the secure online resource 204.

In case, i.e., responsive to, the access agent 220 determines that the accessed online resource may not be an authorized resource, the access agent may prevent the user 202 from accessing it and may prevent transmission of the access credentials to the online resource which may potentially be phishing resource impersonating as the secure online resource 204 as part of an ATO in attempt to compromise one or more accounts of the user 202.

In case of the local access agent 220A, it may block access to potentially fraudulent online resources by blocking the access requests at the access application(s) and preventing transmission of the requests from the client device 200. In case of the remote access agent 220B and 220C, the remote access agent(s) 220B and/or 220C may intercept access requests originating from the client device 200 to access potentially fraudulent online resources and block them thus preventing the requests from reaching the target potentially fraudulent online resources.

The access agent 220 may further configure one or more of the secure online resources 204 to enforce MFA, for example, 2FA for authenticating the user 202 before granting him access to the secure online resources 204. Moreover, the access agent 220 may automatically configure the secure online resource(s) 204 to enforce MFA on behalf of the user 202 without intervention of the user 202 and optionally without notification and/or knowledge of the user 202. For example, using the APIs of one or more applications, services, and/or agents, the access agent 220 may configure and/or adjust one or more access settings defined for one or more of the secure online resources 204 to require MFA. For example, in case of a mobile phone client device 200, the access agent 220, using the API of the mobile phone general settings service, may manipulate and configure the access settings of one or more of the secure online resources 204 to require MFA.

As shown at 106, the access agent 220 may obtain access credentials of the user 202 using his associated client device 200 to access a secure online resource 204. Typically, as described herein before, the secure online resource 204 is identified by the access agent 220 as a genuine and legitimate secure online resource 204 authorized for access by the user 202.

The access agent 220 may receive, fetch, intercept, and/or otherwise obtain the access credentials of the user 202 from one or more sources, using one or more methods, techniques and/or modes.

For example, the access agent 220 may monitor one or more of the HMIs of the user interface 216, for example, a keyboard, a microphone, a camera, and/or the like, and intercept user input comprising access credentials provided by the user 202 for accessing the secure online resource 204.

In another example, the access agent 220 may fetch the access credentials of the user 202 from one or more records, for example, a file, a list, a table, a cookie, and/or the like, in response to detection of the user 202 attempting to access the secure online resource 204. Moreover, the access agent 220 may fetch the access credentials of the user 202 from one or more secure records (e.g., encrypted record), applications, and/or services, and/or plug-ins, used for storing, maintaining, generating, and/or managing access credentials (e.g., user name, account password, token, etc.), for example, a credentials vault, a credentials management application, and/or the like. The access credentials record(s) and/or applications may be stored, deployed and/or executed by the client device 200, and/or by one or more remote resources, for example, a remote storage server, a cloud based password management service, and/or the like, and/or a combination thereof, i.e., a combination of local and remote records, applications, services, and/or plug-ins.

The methods employed by the access agent 220 to obtain the access credentials of the user 202 may depend on the deployment mode and/or architecture of the access agent 220.

For example, in case of the local access agent 220A, the access agent 220A may monitor the HMI(s) of the client device 200 to intercept user input comprising the access credentials provided by the user 202 for accessing the secure online resource 204.

In another example, in case of the remote access agents 220B and/or 220C, collectively designated remote access agents 220BC, the remote access agents 220BC may detect one or more requests for accessing the secure online resource 204 which is received from the client device 200 via the network 206. In some embodiments, the access request may include the access credentials of the user 202 and/or part thereof and the remote access agents 220BC may extract the credentials from the requests.

Additionally, and/or alternatively, the remote access agents 220BC may identify the user 202 and/or his associated client device 200 according to, for example, a username, an account identifier (ID), an Internet Protocol (IP) address, an device ID of the client device 200, and/or the like and may fetch access credentials corresponding to the user 202 from one or more local and/or remote access credentials records and/or applications used for storing and/or managing access credentials of users such as the user 202 accessing the secure online resource 204.

In another example, the local access agent 220A may operate in combination with one or more of the remote access agents 220B and/or 220B to obtain the access credentials. For example, the local access agent 220A may intercept part of access credentials provided by the user 202 via the user interface 216, for example, a username, an account ID, and/or the like and transmit them to the remote access agent 220B and/or 220C which may fetch the remainder of the access credentials, for example, a password, a code, and/or the like from one more credentials storage records and/or applications.

Optionally, the access agents 220 may generate automatically access credentials for the user 202 for accessing the secure online resource 204. Moreover, the access agent 220 may conceal the automatically generated access credentials from the user 202 such that the user 202 is not exposed to the access credentials. The access credentials automatically generated by the access agent 220 may be therefore highly secure and immune to leak, interception, and/or compromise by malicious parties, for example, a resident malware, and/or the like configured to monitor one or more of the HMI(s) of the client device 200 and intercept data exchanged between the user 202 and his client device 200.

For example, the access agent 220 may create automatically a domain specific password for the specific user 202 for the specific secure online resource 204 and hide the automatically created password from the user 202. In another example, the access agent 220 may create domain specific password for each secure online resource 204 using one or more cryptographic hash functions which may create hash based passwords derived from a seed created based on a password the user 202 originally inserted (entered) to access the secure online resource 204 and a name of the secure online resource 204 (e.g., domain name, service name, etc.). Such a cryptographic based password may be highly robust and immune to cyber-attacks, for example, brute force attack.

Optionally, the access agent 220 may prevent the user 202 from inserting and/or providing his access credentials to prevent inadvertent disclosure of the access credentials (e.g., password) to a malicious party. In particular, the access agent 220 may prevent the user 202 from inserting his access credentials in case (responsive to) the accessed online resource cannot be identified as the secure online resource 204 with sufficient certainty and/or confidence and may therefore potentially be an online resource imitating as the secure online resource 204 as part of a cyber-attack, for example, ATO.

The access agent 220 may monitor one or more HMI interfaces of the client device 200 which may be used by the user 202 to insert data including his access credentials, for example, a keyboard, a touchscreen, and/or the like. The access agent 220 may therefore intercept data provided by the user 202 and in case it detects (i.e., responsive to detecting) that the inserted data comprises an initial part of the access credentials, or otherwise infer that the user intends to enter credentials (for example, based on characteristics of the input form), the access agent 220 may operate one or more of the HMIs to prevent the user 202 from inserting the access credentials.

Moreover, in order to prevent leakage of the access credentials from the access agent 220 itself and/or the storage resources it uses, (e.g., database), the access agent 220 may not store the complete access credentials of the user 202 to the secure online resource 204 but rather only a part of the access credentials for example, an initial part of the access credentials. Furthermore, in order to ensure that not even these partial access credentials may be compromised, the access agent 220 may have access to only an encrypted form of the partial access credentials. For example, the initial part of the access credentials may comprise a hash value computed using one or more hash functions for the initial part of the access credentials.

For example, assuming a password of the user 202 for the secure online resource 204 is “rEd-Flames”. In such case, one or more initial parts of the password, for example, “rEd-”, “rEd-f”, and/or the like may be encrypted, for example, associated with respective hash values computed using the hash function(s) which may serve as partial password hashes.

The access agent 220 may monitor the user interface 216, specifically the HMI(s) of the client device 200 to detect user input potentially matching an encrypted initial part of the access credentials of the user 202. In particular, the access agent may intercept user input gradually inserted via the user interface and gradually encrypt the intercepted user input. This means that the access agent 220 may compute or encrypt a plurality of partial values for data (e.g. text) gradually inserted via the user interface 216. For example, assuming a certain string “12345678” is inserted by the user 202 via the user interface 216 (e.g. keyboard), the access agent 220 may encrypt data sequences “12”, “123”, “1234”, and/or the like. For example, the access agent may compute a respective hash value for each data sequence using the same hash function(s) used to compute the initial part of the access credentials.

The access agent 220 may repeatedly match between the resultant encrypted user input and one or more of the stored encrypted initial parts to identify user input which matches the stored initial part(s) of the access credentials which may be indicative that the user 202 is potentially inserting his access credentials.

For example, assuming the access agent 220 intercepts a first user input provided via the user interface 216 which comprises the character “r”. The access agent 220 may encrypt the intercepted character “r”, for example, compute a hash value for the character “r”. The access agent 220 may then compare between the hash value of the character “r” and the stored encrypted initial part, for example, the hash value computed for the initial part “rEd-”. Since the two hash value do not match, the access agent 220 may take no action. Further assuming the character “E” is then inserted via the user interface 216 and intercepted by the access agent. The access agent 220 may encrypt the sequence of characters intercepted so far, i.e., “rE”, for example, compute a hash value for the sequence “rE” and again compare between the hash value of the sequence “rE” and the stored encrypted initial part, for example, the hash value computed for the initial part “rEd-”. Again, since the two hash value do not match, the access agent 220 may take no action. The access agent 220 may continue intercepting gradually inserted user input, encrypt the new sequence of use input and repeatedly compare the encrypted value to the hash value computed for the initial part “rEd-”.

In case of, i.e., responsive to, a match between the intercepted sequence of user input and the stored initial part of the access credentials, the access agent 220 may determine that there is a high probability the user 202 may be providing his access credentials.

Moreover, in response to detection of the match between the intercepted user input and the stored encrypted initial part of the access credentials, the access agent 220 may initiate one or more actions.

The actions initiated by the access agent 220 may include, for example, generating one or more notifications to alert a potential risk arising from inserting the access credentials. For example, the access agent 220 may issue one or more notification(s) may to alert the user 202 of the potential risk via one or more textual, visual, and/or audible messages and/or signals presented via the user interface 216 of the client device 200, for example, a screen, a speaker, and/or the like. as such the user 202 may stop inserting the access credential and the full access credentials may not be exposed and/or compromised by malicious party(s).

In another example, the access agent 220 may issue one or more notifications to alert one or more remote parties of the potential risk, for example, a security system, an IT person, and/or the like. For example, the access agent 220 may transmit one or more messages to a remote cyber security system associated with the user 202, for example, an enterprise security system. In another example, the access agent 220 may transmit one or more email messages, text messages, and/or the like to one or more IT persons related to the user 202.

The actions initiated by the access agent 220 may further include active actions to prevent the user 202 from inserting his access credentials and thus preventing the access credential from being exposed and/or compromised. For example, the access agent 220 may control the user interface 216, for example, a keyboard, a touchscreen, and/or the like to prevent insertion of data by the user 202. Such actions may be carried out, for example, by the local access agent 220 and/or by a local agent controlled by one or more of the remote access agents 220B and/or 220C to interact with one or more applications, drivers OS services and/or the like to control the user interface 216. In another example, one or more of the access agents 220A, 220B, and/or 220C may block and/or disable one or more input fields in a webpage of the online resource thus preventing the user 202 from inserting data at these fields. Such actions may be initiated by controlling a web browser rendering the webpage and/or accessing the webpage itself, e.g., using code injected into the webpage.

As shown at 108, the access agent 220 may transmit the access credentials of the user 202 to the secure online resource 204.

Again, transmission of the access credentials to the secure online resource 204 may depend on the deployment of the access agent 220. For example, in case of the local access agent 220A, the local access agent 220A may transmit the intercepted and/or fetched access credentials of the user 202 to the secure online resource 204 via the network 206. For example, the local access agent 220A may transmit to the secure online resource 204 one or more access, authentication, and/or verification requests comprising the access credentials of the user 202 and/or part thereof. In another example, the remote access agent 200B and 200C may receive the access credentials of the user 202 from the local access agent 220A and/or fetch them from one more credentials storage records and/or applications as described herein before and transmit them to the secure online resource 204.

As shown at 110, the access agent 220 may intercept one or more MFA tokens transmitted from the secure online resource 204 and/or on behalf of the secure online resource 204 in response to receiving the access credentials of the user 202.

The MFA tokens may comprise, for example, one or more codes, strings, passwords, and/or the like. In another example, the MFA tokens may comprise one or more Time based One Time Passwords (TOTP) which are valid for a limited time after which they expire and are no longer valid for use.

As known in the art, while the user 202 using his associated client device 200 may access the secure online resource 204 via a first communication channel of the client device 200, the MFA token(s) may be transmitted from the online resource 204 to the client device 200 via a second communication channel. The second communication channel through which the client device 200 may receive the MFA token(s) may include, for example, one or more text messages, one or more email messages, one or more voice messages, one or more notifications generated by one or more applications, and/or the like.

For example, the user 202 may typically use a web browser, a proprietary access agent, and/or the like to access the secure online resource 204 via one or more network channels and/or ports (first communication channel), for example, the internet, a corporate network, a Virtual Private Network (VPN) and/or the like. In such case, the secure online resource 204 may transmit one or more MFA tokens in one or more messages transmitted via a second communication channel of the client device 200. For Example, the secure online resource 204 may use a phone number associated with the user 202, typically the phone number of his associated client device 200 to transmit to the client device 200 one or more text messages, for example, a Short Message System (SMS) message, a WhatsApp message, and/or the like comprising the MFA token(s). This two factor approach relies on the separation/loose coupling between the network or device used to access the secure resource and the one used to transmit the MFA token. In another example, the secure online resource 204 may transmit one or more email messages comprising the MFA token(s) to an email address associated with the user 202.

The secure online resource 204 may receive, fetch and/or obtain the contact information relating to the user 202 and/or his associated client device 200, for example, phone number, email address, and/or the like from one or more records associating the user 202 with his contact information. Such information may be provided by the user 202 and stored, for example, when the user 202 registers and/or signs up to the secure online resource 204.

The access agent 220 may intercept the MFA token(s) by accessing, communicating, and/or interacting with one or more applications, services, systems, and/or platforms through which the MFA token(s) are received. For example, in case the MFA token(s) are received in one or more SMS and/or WhatsApp messages, the access agent 220 may intercept the messages containing the MFA token(s) by communicating with one or more text messages applications and/or services, for example, a SMS application, a WhatsApp application, and/or the like to intercept the messages containing the MFA token(s). In another example, the in case the MFA token(s) are received in one or more email messages, the access agent 220 may intercept the messages containing the MFA token(s) by communicating with one or more email application executed on the client device 200 and/or with one or more remote email servers serving the email account of the user 202, and/or the like.

In particular, the access agent 220 may intercept the MFA token(s) before the MFA token(s) is presented to the user 202, viewed and/or accessed by the user 202.

As described herein before, the exact configuration and/or operation of the access agent 220 to intercept the MFA token(s) may depend on its deployment and/or architecture. For example, assuming the MFA token(s) are received from the secure online resource 204 in one or more text messages, in case the local access agent 220A is deployed, the local access agent 220A may intercept the MFA token(s) by accessing and/or communicating with one or more of the text message applications locally executed by the client device 200. However, in case of the remote access agents 220B and/or 220C, the remote access agents 220B and/or 220C may intercept the MFA token(s) by communicating with one or more local agents executed by the client device 200, for example, the local access agent 220A, and/or another specifically deployed agent which may extract the MFA token(s) from the text message application(s) and transfer the token(s) to the remote access agents 220B and/or 220C or alternatively forward the text message(s) to the remote access agents 220B and/or 220C.

In another example, assuming the MFA token(s) are received from the secure online resource 204 in one or more email messages, in case of the local access agent 220A, the local access agent 220A may intercept the MFA token(s) by accessing and/or communicating with one or more email applications locally executed by the client device 200. In another example, the local access agent 220A, as well as the remote access agents 220B and/or 220C may access an email service hosting the email account of the user 202 and access the email account of the user 202 to retrieve the MFA token(s). Additionally, and/or alternatively, the remote access agents 220B and/or 220C may intercept the MFA token(s) included in email message(s) by communicating with one or more local agents executed by the client device 200, for example, the local access agent 220A, and/or another specifically deployed agent which may get the MFA token(s) from the locally executed email message application(s) and transfer the MFA token(s) to the remote access agents 220B and/or 220C.

Optionally, the access agent 220 may analyze the received access token(s) and/or the received messages comprising the MFA token(s) in order to determine, evaluate, and/or check whether the MFA token(s) are received from a legitimate and genuine secure online resource 204 which may be safely accessed by the user 202. For example, the access agent may inspect the MFA token message(s), and/or message metadata to identify one or more attributes of the secure online resource 204 from which the MFA token(s) originate, for example, a name, a domain, a URL, a source (origin) IP address, an origin phone number, an origin email address, and/or the like. The access agent 220 may then determine whether the MFA token(s) originate from a genuine, legitimate and authorized resource by comparing the attributes identified in the MFA token message(s) with corresponding attributes of genuine secure online resources 204 stored in one or more records and/or by one or more applications as described herein before.

Optionally, one or more MFA tokens may be transmitted from the secure online resource 204 to one or more “special” second communication channels (e.g., email/social media/other account, channel (specialized phone number etc.), resource) which are dedicated for use by the access agent 220. Moreover, one or more of these dedicated second communication channels, for example, an email account, a phone number, an SMS contact, a WhatsApp contact, and/or the like may be inaccessible to the user 202 and optionally even concealed and thus unknown to the user 202.

For example, in the record(s) available to the secure online resource 204, the user 202 may be associated an email account created specifically for use by the access agent 220. In response to receiving the access credentials of the user 202 transmitted from the client device 200, the secure online resource 204 may therefore transmit one or more MFA token to the email address of the specifically created email account. The access agent 220 may access this dedicated email account to retrieve (intercept) the MFA token(s) transmitted by the secure online resource 204. Since the dedicated email account may be typically unknown to the user 202 it may be highly secure and immune to potential cyberattacks initiated in attempt to compromise information used by the user 202.

In another example, in the record(s) available to the secure online resource 204, the user 202 may be associated a destination port of the client device 200, for example, a contact number, a phone number, an IP address, and/or the like which is assigned for dedicated use by the access agent 220 and unknown to the user 202. The access agent 220 may therefore intercept the MFA token(s) transmitted by the secure online resource 204 to the dedicated destination port of the client device 200 while the user 202 completely unaware of the entire sequence.

As shown at 112, which is an optional step, the access agent 220 may optionally discard the received MFA token(s) and/or control one or more of the HMIs of the client device 200, for example, a screen, to prevent presentation of the MFA token(s) to the user 202 thus preventing the user 202 from using, providing and/or inserting the received MFA token(s). As such, the user 202 may be unable to manually provide the MFA token(s) to online resources which may be fraudulent resources used for malicious cyber-attacks, for example, ATO.

For example, assuming the MFA token(s) are received in one or more text and/or email messages. In such case, after intercepting the message(s) and retrieving the MFA token(s), the access agent 220 may interact with the messages application(s), for example, an SMS application, an email application, and/or the like, for example, via its API, to delete the MFA token message(s) such that the user 202 may be unable to access them to see, get, and/or use the MFA token(s). Additionally, and/or alternatively, the access agent 220 may interact with the messages application(s) to lock access, view, and/or display of at least some of the messages, in particular the MFA token message(s).

In another example, assuming one or more MFA tokens, for example, a TOTP, and/or the like are generated on the client device 200 of the user 202. In such case, the access agent 220 may interact with one or more token generation applications locally executed by the client device 200, for example, a TOTP engine application such as (for example only) Google Authenticator, to import a common key (shared secret) shared between the locally executed token generation applications and the remote secure online resource 204. As such, the access agent 220 may produce one or more MFA tokens based on the shared key. The access agent 220 may be configured to hide the generated MFA token(s) from the user 202

In another example, one or more MFA tokens received by the client device 200 may be encrypted such that while this token(s) may be decrypted and used by the access agent 220, the encrypted MFA token(s) are inaccessible and unavailable to the user 202 who is incapable of decrypting the MFA token(s).

As shown at 114, the access agent 220 may transmit the received MFA token(s) to the secure online resource 204. Specifically, the access agent 220 may transmit the received MFA token(s) to the secure online resource 204 after determining, as described herein before, that the secure online resource 204 is genuine, legitimate and/or authorized for access by the user 202.

The secure online resource 204 may be configured to authenticate the user 202 according to the received MFA token(s) and accordingly grant or deny the user 202 access to the secure online resource 204. In particular, the secure online resource 204 may verify the MFA token(s) jointly with the access credentials provided by the access agent 220 to ensure that they both relate to the same user 202.

In case of, i.e., responsive to, successful verification of the MFA token(s) (combined with the access credentials), the secure online resource 204 may authenticate the user 202 and grant him access to the secure online resource 202. However, in case (responsive to) the secure online resource 204 fails to verify the MFA token(s), specifically jointly with the access credentials submitted for the user 202, authentication of the user 202 may fail and the user 202 may be denied access to the secure online resource 204.

Typically, the access agent 220 may be configured to transmit the received MFA token(s) to the secure online resource 204 automatically on behalf of the user 202 without intervention and/or interaction with the user 202.

The access agent 220 may apply one or more methods for transmitting the MFA token(s) for the secure online resource 204. For example, the access agent 220 may insert one or more MFA token (text) strings into one or more corresponding fields presented on a display of the client device 200. To this end, the access agent may interact with one or more functions, services, applications (including web browsers via extension or plugin or otherwise), injected JavaScript code, systems calls, OS routines and/or procedures and/or the like which are configured to control text input. In another example, the access agent 220 may provide the MFA token(s) for transmission to the secure online resource 204 by one or more networking functions, services, OS procedures and/or system calls configured to transmit data via the network 206.

Optionally, the MFA token(s) may be provided and transmitted to the secure online resource 204 through an at least partially manual process conducted by the user 202 rather than through the automated process executed by the access agent 220 as described herein before. In order to prevent the user 202 from inserting and/or providing MFA token(s) to fraudulent online resources imitating secure online resources 204, the access agent 220, for example, the local access agent 220A may be optionally configured to control one or more HMIs of the client device 220 to prevent the user 202 from inserting and/or providing the MFA token(s).

In particular, the access agent 220 may prevent the user 202 from inserting and/or providing MFA token(s) for accessing an online resource which is not identified as an authorized secure online resource 204, since it may be a potential fraudulent resource, for example, a phishing resource imitating as a legitimate secure online resource 204 for one or more cyber-attacks, for example, ATO of one or more accounts of the user 202.

Moreover, the access agent 220 may analyze and/or identify a context in which the user 202 attempts to insert and/or provide the MFA token(s) and prevent the user 202 from inserting and/or providing MFA token(s) based on the identified context.

For example, the local access agent 220A may monitor HMI(s) of the client device 200, for example, keystrokes on a keyboard of the client device 200. The local access agent 220A may further identify and monitor one or more MFA fields displayed on a screen of the client device 200 in which MFA token(s) should be inserted. The local access agent 220A may therefore determine that in the context of insertion of data through the keyboard at the MFA fields and may control the client device 202 and/or one or more of its HMI(s) to prevent insertion of this data which may comprise the MFA token(s). However, assuming the local access agent 220A determines that the data is not inserted at the MFA fields but rather at other text fields and/or windows not relating to MFA tokens, the access agent 220A may not prevent the user 202 from operating the keyboard to insert and/or text.

In another example, in case of the remote access agent 220B which may be embedded in one or more webpages and/or websites of the secure online resource 204, the remote access agent 220B may detect that text is inserted in one or more MFA fields of one or more of the webpage(s) and may prevent display of the inserted text which may comprise the MFA token(s).

Furthermore, the access agent 220 may be configured to identify and determine as early as possible that the user 202 attempts to insert and/or provide the MFA token(s) in attempt to access a fraudulent online resource imitating the secure online resource 204. To this end, the access agent 220 may be configured to identify portions of the MFA token(s), specifically initial portions, for example, a sub-string of the MFA token(s) and prevent the user 202 from further inserting the complete MFA token(s) since the inserted MFA token(s) may be intercepted by one or more malicious parties, for example, a resident malware, a monitoring malware and/or person, and/or the like. For example, assuming a certain MFA token comprises a string “137246”. In such case, the access agent 220 may be configured to identify one or more sub-strings, for example, “13”, “137”. “1372” and block the user 202 from further inserting text when one or more of these sequences are detected.

Receiving the MFA token(s) and transmitting it to the secure online resource 204 on behalf of the user 202 and without his intervention may significantly increase security and immunity of the user 202 and his associated client device 200 to ATO attacks. First, since the MFA token(s) is not presented (shown, disclosed) to the user 202, the MFA token(s) may be significantly secured and prevented from being compromised, for example, intercepted, captured, recorded, leaked, and/or the like by potential malicious parties, for example, a person and/or device monitoring the display of the client device 200, a malware recording screen content of the client device 200, and/or the like may be unable to intercept the MFA token(s). Moreover, since the user 202 does not provide (insert) the MFA token(s) through the HMI(s) of the client device 200 for accessing the secure online resource 204, potential malicious parties, for example, a malware installed on the client device 200 to log keyboard keystrokes, a malware recording screen content of the client device 200, and/or the like may be unable to intercept the MFA token(s).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms MFA token, communication channel, and user interface HMI are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of automating multi-factor authentication (MFA) to securely authenticate users accessing secure online resources, comprising:
using at least one processor to execute a computer program code for:
obtaining access credentials of at least one user using at least one client device to access at least one secure online resource;
transmitting the access credentials to the at least one secure online resource;
intercepting, automatically via a background process, at least one MFA token transmitted by the at least one secure online resource to the at least one client device in response to receiving the access credentials; and
transmitting, automatically in a background process, the at least one MFA token to the at least one secure online resource configured to authenticate the at least one user according to the received at least one MFA token and grant or deny the at least one user access accordingly.

2. The computer implemented method of claim 1, wherein the at least one user accesses the at least one secure online resource via a first communication channel of the at least one client device while the at least one MFA token is received via a second communication channel of the at least one client device.

3. The computer implemented method of claim 1, further comprising discarding the at least one MFA token before presented to the at least one user.

4. The computer implemented method of claim 1, further comprising controlling at least one user interface of the at least one client device to prevent the at least one user from manually inserting the at least one MFA token.

5. The computer implemented method of claim 4, wherein the controlling of the at least one user interface to prevent manual insertion of the at least one MFA token in case the at least one secure online resource is not identified as an authorized resource.

6. The computer implemented method of claim 1, further comprising verifying the at least one secure online resource is genuine before enabling the at least one user to access the at least one online resource.

7. The computer implemented method of claim 1, wherein the access credentials are inserted by the at least one user using at least one user interface of the at least one client device.

8. The computer implemented method of claim 1, further comprising generating automatically access credentials for the at least one secure online resource and concealing the automatically generated access credentials from the at least one user.

9. The computer implemented method of claim 1, further comprising monitoring at least one user interface of the at least one client device to detect user input potentially matching at least one stored encrypted initial part of the access credentials by:
intercepting user input gradually inserted by the at least one user via the at least one user interface;
gradually encrypting the intercepted user input, and
repeatedly matching between the resultant encrypted user input and the at least one stored encrypted initial part.

10. The computer implemented method of claim 9, further comprising initiating at least one action in response to detecting user input matching the at least one stored encrypted initial part, the at least one action is a member of a group consisting of: generating at least one notification, and controlling at least one user interface of the at least one client device to prevent the at least one user from manually inserting further portions of the access credentials.

11. The computer implemented method of claim 1, further comprising verifying at least one code segment executed by the at least one secure online resource matches a corresponding stored known good at least one code segment before transmitting the access credentials to the at least one secure online resource.

12. The computer implemented method of claim 11, wherein the at least one code segment comprises at least one common code segment excluding user specific code and thus executed similarly for a plurality of users.

13. The computer implemented method of claim 11, wherein the at least one code segment comprises at least one user specific code segment adjustable according to at least one user attribute relating to the at least one user and/or the at least one client device, the at least one user attribute is a member of a group consisting of: personal information, geolocation, timing, and an operational parameter of the client device.

14. The computer implemented method of claim 13, wherein the at least one user specific code segment generated specifically with respect to the at least one user is associated with a user specific signature expressing a unique execution of the at least one user specific code segment for the at least one user.

15. The computer implemented method of claim 1, wherein the at least one MFA token comprises a one-time password (OTP).

16. The computer implemented method of claim 1, wherein receiving of the at least one MFA token from the at least one secure online resource is done via at least one message, the at least one message is a member of a group consisting of: a text message, an email message, a voice message, and an application notification.

17. An authentication apparatus for automating multi-factor authentication (MFA) to securely authenticate users accessing secure online resources, comprising:
a program store storing a code; and
at least one processor coupled to the program store, the at least one processor is configured to execute the code, the code comprising:
code instructions to receive access credentials inserted by at least one user using at least one client device to access at least one secure online resource;
code instructions to transmit the access credentials to the at least one secure online resource;
code instructions to intercept, automatically in a background process, at least one MFA token transmitted by the at least one secure online resource to the at least one client device in response to receiving the access credentials; and
code instructions to transmit, automatically in a background process, the at least one MFA token to the at least one secure online resource configured to authenticate the at least one user according to the received at least one MFA token and grant or deny the at least one user access accordingly.

18. The apparatus of claim 17, wherein the at least one processor comprises at least one processor of the at least one client device.

19. The apparatus of claim 17, wherein the at least one processor comprises at least one processor of at least one server processing and/or providing access to the at least one secure online resource.

20. The apparatus of claim 17, wherein the at least one processor comprises at least one processor of a traffic control service deployed to route all communication traffic between the at least one client device and the at least one secure online resource.
